(19) United States
(12) Patent Application Publication
(10) Pub. No.: US 2017/0141949 A1
(43) Pub. Date: May 18, 2017

(54) METHOD AND APPARATUS FOR PROCESSING ALARM INFORMATION IN CLOUD COMPUTING

(71) Applicants: Le Holdings (Beijing) Co., Ltd., Beijing (CN); LeCloud Computing Co., Ltd., Beijing (CN)

(72) Inventor: Can ZHANG, Beijing (CN)

(21) Appl. No.: 15/246,541

(22) Filed: Aug. 25, 2016

Related U.S. Application Data
(63) Continuation of application No. PCT/CN2016/082825, filed on May 20, 2016.

(30) Foreign Application Priority Data
Nov. 13, 2015 (CN) 201510781828.X

(51) Int. Cl. H04L 12/24; H04L 29/08

(52) U.S. Cl. CPC H04L 41/0636; H04L 67/141; H04L 67/10

(57) ABSTRACT

Disclosed are a method and an apparatus for processing alarm information in a cloud computing. The method includes: establishing a corresponding relation between services and physical resources of nodes at all levels, wherein the physical resources relied on for executing the services; and generating aggregated alarm information based on the corresponding relation between the services and the physical resources when a physical resource or a service gives alarms.

### CROSS-REFERENCE TO RELATED APPLICATIONS

This application is a continuation of International Application No. PCT/CN2016/082825, filed on May 20, 2016, which is based upon and claims priority to Chinese Patent Application No. 201510781828.X, filed on Nov. 13, 2015, the entire contents of which are incorporated herein by reference.

### TECHNICAL FIELD

The present disclosure relates to the field of internet technologies, and more particularly, to a method and an apparatus for processing alarm information in a cloud computing.

### BACKGROUND

Cloud computing is a computing mode based on Internet. By using this mode, shared software and hardware resources and information may be provided for computers and other devices as needed. In a cloud computing environment, in order to ensure stability in the process of cloud computing, generally physical resources (memory utilization and disk utilization of a server and so on) and services (database services, storage services and so on) of a computer may be monitored. When an exception (fault) happens in a cloud computing, it may trigger alarms and notify operation and maintenance personnel to dispose the exception through an E-mail, a short message or telephone, etc.

Operation and maintenance personnel need to handle with faults according to alarm information, thus operation and maintenance personnel often need to manage a large number of computer nodes. However, in a large-scale cloud computing environment, occurrence of an exception is relatively frequent. Therefore, a monitoring alarm system in the cloud computing environment may send a huge amount of alarm information when an exception happens. To a single operation and maintenance personnel managing a large number of computer nodes, the huge amount of alarm information may submerge effective information, which is disadvantageous to the operation and maintenance personnel to quickly locate a problem and timely resume normal services. Therefore, how to effectively control a quantity of alarms in the cloud computing environment becomes a problem need to be solved urgently in the field of cloud computing at present.

### SUMMARY

The present disclosure provides a method and an apparatus for processing alarm information in a cloud computing, which are used for solving a defect in the prior art that a monitoring alarm system of a cloud computing environment may send a huge amount of alarm information when an exception happens, thereby achieving the objective of effectively reducing the quantity of alarms.

In a first aspect, embodiments of the present disclosure provide a method for processing alarm information in a cloud computing, implemented by a server, including:

establishing a corresponding relation between services and physical resources of nodes at all levels, wherein the physical resources are relied on for executing the services; and

generating aggregated alarm information based on the corresponding relation between the services and the physical resources when a physical resource or a service gives alarms.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for processing alarm information in a cloud computing mentioned by embodiments of the present disclosure.

In a third aspect, embodiments of the present disclosure provide a non-transitory computer-readable storage medium storing executable instructions that, when executed by an electronic device, cause the electronic device to perform any methods for processing alarm information in a cloud computing mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for processing alarm information in a cloud computing in accordance with some embodiments;

FIG. 2 is a schematic structural diagram of a tree structure in the prior art;

FIG. 3 is a schematic structural diagram of a physical resource tree built in accordance with some embodiments;

FIG. 4 is a schematic diagram of a correspondence table between services and physical resources created by some embodiments;

FIG. 5 is a block diagram showing constitution of an apparatus for processing alarm information in a cloud computing in accordance with some embodiments; and

FIG. 6 is a block diagram showing constitution of an electronic device in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying. Apparently, the described embodiments are some but not all of the embodiments of the present disclosure.

In a cloud computing environment, in order to ensure stability in the process of cloud computing, generally physical resources (memory utilization, disk utilization and so on) and services (database services, storage services and so on) of a computer may be monitored. When an exception occurs in a cloud computing, alarm information can be sent to operation and maintenance personnel to handle with the exception. In the prior art, a monitoring alarm system may send a piece of alarm information for each exception. However, occurrence of exceptions under a large-scale cloud computing environment is relatively frequent. Therefore, effective information can be submerged in a huge amount of alarm information sent to operation and maintenance personnel, which is disadvantageous to the operation and maintenance personnel to quickly locate a problem and timely resume normal services.

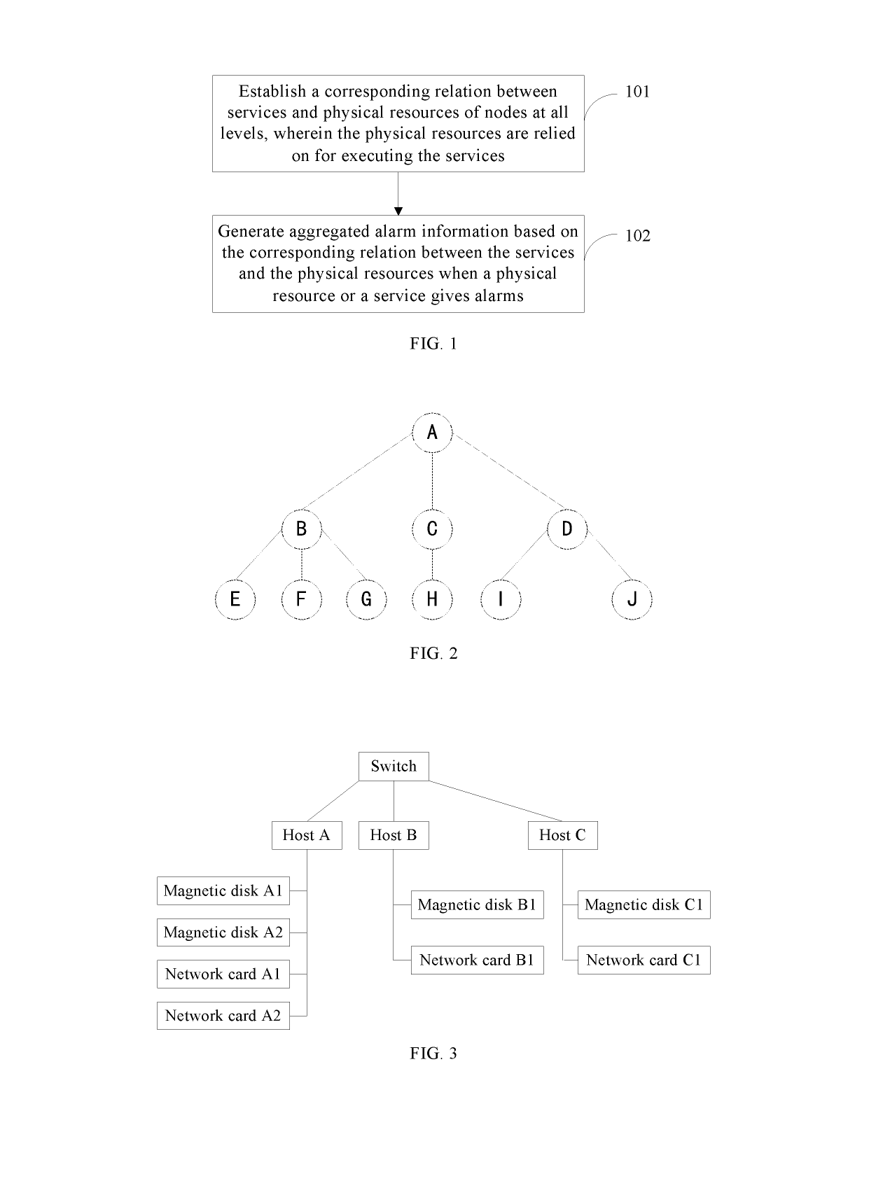

To solve the defect in the prior art that the monitoring alarm system of the cloud computing environment may send a huge amount of alarm information in case of an exception, some embodiments of the present disclosure provide a method for processing alarm information in a cloud computing, implemented by a server, as shown in FIG. 1, the method includes:

101: The server establishes a corresponding relation between services and physical resources of nodes at all levels where the physical resources are relied on for executing the services.

Physical resources of nodes at all levels may be used when a certain service is executed by using cloud computing, and generated alarm information may include both service alarm information and physical resource alarm information. Therefore, to understand whether a certain causal relationship exists between the generated service alarm information and the physical resource alarm information, in the embodiments of the present disclosure, Step 101 needs to be executed to establish a corresponding relation between services and physical resources of nodes at all levels where the physical resources are relied on for executing the services. For example, if both a certain service and physical resources of nodes at a certain level generate alarm information, and a corresponding relation exists between them, namely, the physical resources of nodes at a certain level are relied on to execute the certain service, this signifies that alarm information generated by the certain service can be caused by an exception of the physical resources of nodes at a certain level.

102: The server generates aggregated alarm information based on the corresponding relation between the services and the physical resources when a physical resource or a service gives alarms.

After the corresponding relation between the services and the physical resources of nodes at all levels is obtained in the foregoing Step 101, the alarm information can be generated by aggregating alarm information generated by the physical resources or by aggregating alarm information generated by the physical resources and the services based on a relation among the physical resources and the corresponding relation between the physical resources and the services, thereby reducing the quantity of alarm information sent by the monitoring alarm system in the cloud computing environment.

In the method for processing alarm information in a cloud computing provided by the embodiment of the present disclosure, by establishing a corresponding relation between services and physical resources of nodes at all levels where the physical resources are relied on for executing the services and by generating aggregated alarm information based on the corresponding relation between the services and the physical resources when a physical resource or a service give alarm, it is avoided occurrence in the prior art that a monitoring alarm system of a cloud computing environment may send a huge amount of alarm information when an exception happens, thereby achieving an effect of effectively reducing alarm information to be sent.

To better understand the method as shown in the foregoing FIG. 1, the embodiment of the present disclosure will describe in detail steps in FIG. 1 with reference to alarm information generated the monitoring alarm system in the cloud computing environment.

Cloud computing is a computing mode based on Internet. By using cloud computing, shared software and hardware resources can be provided for computers and other devices as needed. Therefore, various hardware resources can be used in the cloud computing environment, namely, the physical resources in the embodiments of the present disclosure. Physical resources used in a cloud computing are interconnected, a tree structure which has multilevel nodes is adopted for descripting a data structure relation. Therefore, to clearly understand a relation among various physical resources in a cloud computing, in the embodiments of the present disclosure, a physical resource tree is built by classifying the physical resources used in a cloud computing according to a tree structure, where the physical resource tree at least includes physical resources of three level nodes. For example, if the physical resource tree includes physical resources of three-level nodes: respectively physical resources of first-level nodes, physical resources of second-level nodes and physical resources of third-level nodes, where the physical resources of second-level nodes are subordinate to and connected to the physical resources of first-level nodes, and the physical resources of third-level nodes are subordinate to and connected to the physical resources of second-level nodes.

In the embodiments of the present disclosure, in order to build a physical resource tree by classifying the physical resources used in a cloud computing according to a tree structure, it is required to build the physical resource tree by classifying the physical resources according to a structure similar to the tree structure as shown in FIG. 2 on a basis of a connecting relation, subordinating relation or coordinating relation of the physical resources with reference to a characteristic that the tree structure can denote a subordinating relation and a coordinating relation among elements. For example, in the embodiments of the present disclosure, if physical resources used in a cloud computing include a switch, a host A, a host B, a host C, a magnetic disk A1, a magnetic disk A2, a network card A1 and a network card A2 on the host A, a magnetic disk B1 and a network card B1 on the host B, and a magnetic disk C1 and a network card C1 on the host C, where the host A, the host B and the host C are connected to the switch; a coordinating relation exists among the host A, the host B and the host C; whereas the magnetic disk Al, the magnetic disk A2, the network card Al and the network card A2 are connected to and subordinate to the host A; the magnetic disk B1 and the network card B1 are connected to and subordinate to the host B; and the magnetic disk C1 and the network card C1 are connected to and subordinate to the host C. Thus the physical resource tree as shown in FIG. 3 can be built by classifying these physical resources according the characteristic of the tree structure. The physical resource tree built in the embodiments of the present disclosure includes physical resources of three-level nodes, where the switch is the physical resources of first-level nodes, the host A, the host B and the host C are the physical resources of second-level nodes and are respectively connected to the switch; the magnetic disk A1, the magnetic disk A2, the network card A1 and the network card A2 are the physical resources of third-level nodes and are respectively connected to the host A; the magnetic disk B1 and the network card B1 are the physical resources of third-level nodes and are respectively connected to the host B; and the magnetic disk C1 and the network card C1 are the physical resources of third-level nodes and are connected to the host C. In the embodiments of the present disclosure, the relation among the physical resources of nodes at all levels can be clearly established by building the physical resource tree, thereby facilitating an aggregation analysis for subsequently generating alarm information for the physical resources of nodes at all levels.

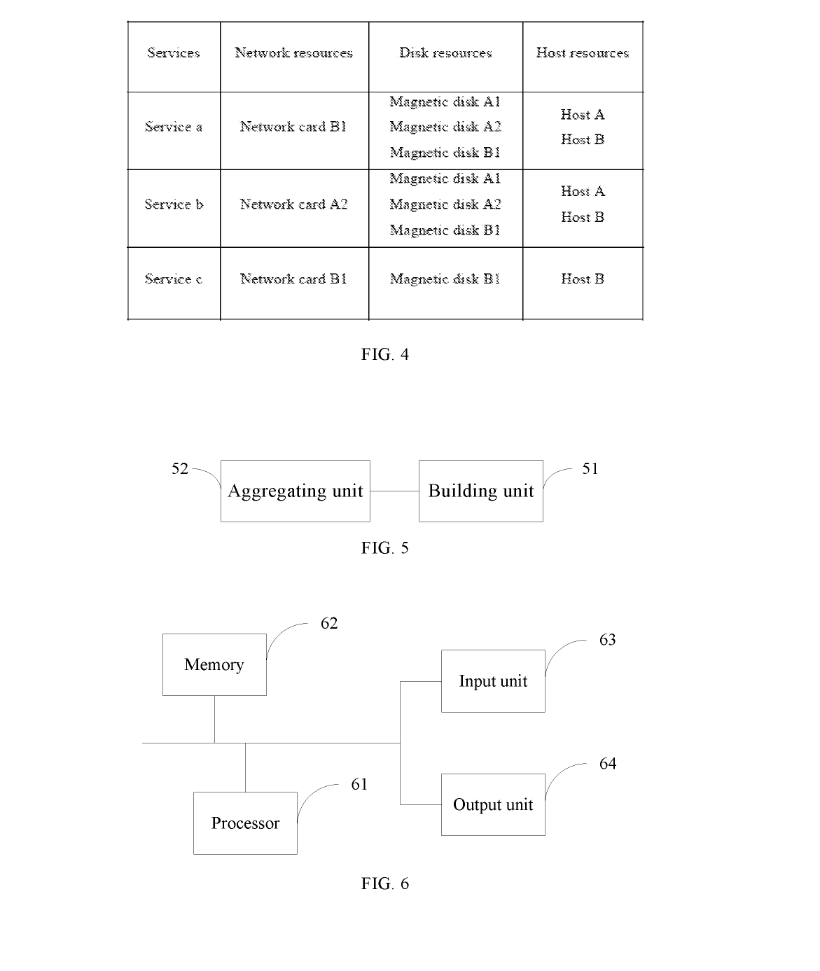

During cloud computing, various tasks can be executed and alarm information may be generated in case of task exception. Therefore, after the relation among physical resources is established through the above mentioned way, in the embodiments of the present disclosure, it is required to establish a corresponding relation between services and physical resources of nodes at all levels where the physical resources are relied on for executing the services, so that when both the services and the physical resources generate alarm information, it is determined whether alarm information generated by the services and alarm information generated by the physical resources can be aggregated by judging whether a relation between the services and the physical resources exists. For example, services required to be deployed in the embodiments of the present disclosure include service a, service b and service c, where execution of the service a relies on the magnetic disk A1, the magnetic disk A2, the magnetic disk B1, the network card B1, the host A and the host B in the foregoing physical resource tree; execution of the service b relies on the magnetic disk A1, the magnetic disk A2, the magnetic disk B1, the network card A2, the host A and the host B in the foregoing physical resource tree; and execution of the service c relies on the magnetic disk B1, the network card B1 and the host B in the foregoing physical resource tree. Therefore, in order to clearly establish the corresponding relation between the services and the physical resources of nodes at all levels where the physical resources are relied on for executing the services, in the embodiments of the present disclosure, various services can correspond to the physical resources of nodes at all levels that are relied on for executing the services, after which, a correspondence table between the services and the physical resources as shown in FIG. 4 is formed. In the embodiments of the present disclosure, the relation between physical resources of nodes at all levels and services can be clearly established by building the correspondence table between the services and the physical resources, thereby facilitating an aggregation analysis for subsequently generating alarm information for the physical resources.

After the physical resource tree and the correspondence table between the services and the physical resources are established through the above way, when the monitoring alarm system generates alarm information, it is required to make an aggregation analysis of the alarm information based on the physical resource tree and the corresponding relation. In actual situation, alarm information includes physical resource alarm information and service alarm information, thus it is required to aggregate the alarm information according to characteristics of the alarm information. There are mainly two processing modes: 1. Alarm information of congeneric physical resources (physical resources of sibling nodes) is aggregated according to the physical resource tree. 2. Aggregated physical resource alarm information and corresponding service alarm information are aggregated according to the physical resource tree and the correspondence table between the services and the physical resources. Specifically, in the embodiments of the present disclosure, illustrations will be made regarding to the foregoing two processing modes.

In the first processing mode, for example, at the moment ports-failure alarm information of the host A, the host B and the host C are generated. It is found by making an analysis of the alarm information that the alarm information is ports-failure information and belongs to congeneric alarm information, and the host A, the host B and the host C generating the congeneric alarm information belong to congeneric physical resources, i.e., physical resources of sibling nodes (physical resources of second-level nodes), which are subordinate to physical resources of the first-level node namely the switch. Therefore, in the embodiments of the present disclosure, the ports-failure alarm information of the host A, the host B and the host C can be aggregated into one aggregated alarm information, which is one switch fault alarm information. Likewise, supposing at the moment the magnetic disk A1 and the magnetic disk A2 on the host A generate alarm information indicating insufficient capacity, it is found by making an analysis of the alarm information that the alarm information in regard to insufficient capacity and belongs to congeneric alarm information, and the magnetic disk Al and the magnetic disk A2 generating the congeneric alarm information belong to congeneric physical resources, i.e., physical resources of sibling nodes (physical resources of third-level nodes), which are subordinate to physical resources of the second-level node namely the host A. Therefore, in the embodiments of the present disclosure, the alarm information indicating insufficient capacity of the magnetic disk A1 and the magnetic disk A2 can be aggregated into one aggregated alarm information, which is one alarm information indicating insufficient capacity of the host A. Therefore, in the first processing mode in which congeneric physical resources (physical resources of sibling nodes) alarm information is aggregated according to the physical resource tree, an aggregation rule thereof can be summarized as below: when physical resources of multiple congeneric slave nodes subordinate to physical resources N of a master node are monitored to generate congeneric alarm information, the congeneric alarm information is aggregated into one aggregated alarm information, which is one alarm information regarding to the physical resources N. Any physical resources having the physical resources of slave nodes can be referred to as the physical resources of the master node. The quantity of physical resource alarm information to be sent can be effectively reduced through the first processing mode, thus it can help enterprises to reduce communication expenses arisen from sending prompt information to operation and maintenance personnel through short messages or phone calls, etc.

In the second processing mode, execution of the service a relies on physical resources including the network card B1, the magnetic disk B1, the magnetic disk A1, the magnetic disk A2, the host A and the host B; execution of the service b relies on physical resources including the network card A2, the magnetic disk A1, the magnetic disk A2, the magnetic disk B1, the host A and the host B; and execution of the service c relies on physical resources including the network card B1, the magnetic disk B1 and the host B. When alarm information of the service a and alarm information of the magnetic disk A1 are generated at the moment, it is found by making an analysis of the service a and the magnetic disk A1 that a corresponding relation (execution of the service a relies on the magnetic disk A1) between the service a and the magnetic disk A1 exists. Therefore, the alarm information of the service a and the alarm information of the magnetic disk A1 can be aggregated into one alarm information indicating that a certain exception of the service a is likely caused by a certain exception of the magnetic disk A1. When alarm information of the service a, alarm information of the service c and alarm information of the host B are generated at the moment, it is found by making an analysis of the service a, the service c and the host B that a corresponding relation (execution of the service a relies on the host B) between the service a and the host B, and there exists a corresponding relation (execution of the service c relies on the host B) between the service c and the host B exists. Therefore, the alarm information of the service a, the alarm information of the service c and the alarm information of the host B can be aggregated into one alarm information indicating that an exception of the service a and an exception of the service c are likely caused by a certain exception of the host B. Likewise, when alarm information of the service a and alarm information of the service b are generated at the moment, and also alarm information indicating insufficient capacity of the magnetic disk A1 and the magnetic disk A2, it is found by making an analysis of the service a, the service b, the magnetic disk A1 and the magnetic disk A2 that a corresponding relation (execution of the service a relies on the magnetic disk A1 and the magnetic disk A2) between the service a and the magnetic disk A1 and the magnetic disk A2 exists; a corresponding relation (execution of the service b relies on the magnetic disk A1 and the magnetic disk A2) between the service b and the magnetic disk A1 and the magnetic disk A2 exists; and further both the magnetic disk A1 and the magnetic disk A2 belong to the congeneric physical resources (physical resources of three-level nodes) and are subordinate to physical resources of a second-level node namely the host A, and both the magnetic disk A1 and the magnetic disk A2 generate congeneric alarm information (alarm information indicating insufficient capacity). Therefore, the alarm information generated by the magnetic disk A1 and the alarm information generated by the magnetic disk A2 may be first aggregated into one alarm information indicating insufficient capacity of the host A, and then on a basis of the alarm information, alarm information related to the service a and alarm information related to the service b are aggregated and finally formed into one alarm information indicating that an exception of the service a and an exception of the service b are likely caused by insufficient capacity of the host A. Therefore, in the second processing mode in which aggregated physical resource alarm information and corresponding service alarm information are aggregated with reference to the physical resource tree and the correspondence table between the services and the physical resources, an aggregation rule thereof can be summarized as below: when both the physical resources of nodes and the services corresponding to the physical resources of nodes are monitored to generate alarm information, alarm information generated by the physical resources of nodes and alarm information generated by the services corresponding to the physical resources of nodes are aggregated into a piece of aggregated alarm information. The quantity of physical resource alarm information to be sent can be effectively reduced through the second processing mode, and thus it can help enterprises to reduce communication expenses arisen from sending prompt information to operation and maintenance personnel through short messages or phone calls, etc. Furthermore, the quality of the alarm information can be improved so that the alarm information contains more valuable information, which can facilitate operation and maintenance personnel to quickly locate a problem, improve operation and maintenance efficiency and save human resources.

As application of the method as shown in FIG. 1, an embodiment of the present disclosure provides an apparatus for processing alarm information in a cloud computing, as shown in FIG. 5, the apparatus includes: a building unit 51 and an aggregating unit 52, where

the building unit 51 is configured to establish a corresponding relation between services and physical resources of nodes at all levels, the physical resources are relied on for executing the services; and

the aggregating unit 52 is configured to generate aggregated alarm information based on the corresponding relation between the services and the physical resources when a physical resource or a service give alarms.

Further, the building unit 51 is configured to build a physical resource tree by classifying the physical resources according to a tree structure on a basis of a connecting relation, subordinating relation or coordinating relation of the physical resources, and establish a corresponding relation between the services and the physical resources of nodes at all levels, the physical resource are relied on for executing the services.

Further, the aggregating unit 52 is configured to aggregate, when physical resources of multiple congeneric slave nodes subordinate to physical resources of a master node are monitored to generate congeneric alarm information, the congeneric alarm information into fault information of the master node.

Further, the aggregating unit 52 is also configured to aggregate, when both the physical resources of nodes and the services corresponding to the physical resources of nodes are monitored to generate alarm information, alarm information generated by the physical resources of nodes and alarm information generated by the services corresponding to them into one aggregated alarm information.

In allusion to the apparatus for processing alarm information in a cloud computing, it should be noted that functions of each unit module used in the embodiment of the present disclosure may be implemented through a hardware processor.

In the apparatus for processing alarm information in a cloud computing provided by the embodiment of the present disclosure, by establishing a corresponding relation between services and physical resources of nodes at all levels that are relied on for executing the services and by generating aggregated alarm information based on the corresponding relation between the services and the physical resources in case of a physical resource alarm or a service alarm, it is avoided occurrence in the prior art that a monitoring alarm system of a cloud computing environment may send a huge amount of alarm information when an exception happens, thereby achieving an effect of effectively reducing alarm information to be sent.

Furthermore, the apparatus for processing alarm information in a cloud computing provided by the embodiment of the present disclosure also can effectively reduce the quantity of physical resource alarm information to be sent, help enterprises to reduce communication expenses arisen from sending prompt information to operation and maintenance personnel through short messages or phone calls and so on, and improve the quality of the alarm information so that the alarm information contains more valuable information, which may facilitate operation and maintenance personnel to quickly locate a problem, improve operation and maintenance efficiency and save human resources.

Further, an embodiment of the present disclosure further provides a non-transitory computer-readable storage medium storing executable instructions, which can be executed by an electronic device to perform any methods for processing alarm information in a cloud computing mentioned by embodiments of the present disclosure.

FIG. 6 is a block diagram of an electronic device which is configured to perform the methods for processing alarm information in a cloud computing according to an embodiment of the present disclosure. As shown in FIG. 6, the device includes: one or more processors 61 and memory 62. A processor 61 is showed in FIG. 6 for an example.

Device which is configured to perform the methods for processing alarm information in a cloud computing can also include: input unit 63 and output unit 64.

Processor 61, memory 62, input unit 63 and output unit 64 can be connected by BUS or other methods, and BUS connecting is showed in FIG. 6 for an example.

Memory 62 can be used for storing non-transitory software program, non-transitory computer executable program and modules as a non-transitory computer-readable storage medium, such as corresponding program instructions/modules for the methods for processing alarm information in a cloud computing mentioned by embodiments of the present disclosure (such as shown in FIG. 5, building unit 51 and aggregating unit 52). Processor 61 performs kinds of functions and processing alarm information in a cloud computing of the electronic device by executing non-transitory software program, instructions and modules which are stored in memory 62, thereby realizes the methods for processing alarm information in a cloud computing mentioned by embodiments of the present disclosure.

Memory 62 can include program storage area and data storage area, thereby the operating system and applications required by at least one function can be stored in program storage area and data created by using the device for processing alarm information in a cloud computing can be stored in data storage area. Furthermore, memory 62 can include high speed Random-access memory (RAM) or non-volatile memory such as magnetic disk storage device, flash memory device or other non-volatile solid state storage devices. In some embodiments, memory 62 can include long-distance setup memories relative to processor 61, which can communicate with the device for processing alarm information in a cloud computing by networks. The examples of said networks are including but not limited to Internet, Intranet, LAN, mobile Internet and their combinations.

Input unit 63 can be used to receive inputted number, character information and key signals causing user configures and function controls of the device for processing alarm information in a cloud computing. Output unit 64 can include a display screen or a display device.

The said module or modules are stored in memory 62 and perform the methods for processing alarm information in a cloud computing when executed by one or more processors 61.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The apparatus embodiment set forth above is merely exemplary, where units described as detached parts can be or not be detachable physically; parts displayed as units can be or not be physical units, i.e., either located at the same place, or distributed on a plurality of network units. Modules may be selected in part or in whole according to actual needs for achieving objectives of the solution of this embodiment.

It can be known from the foregoing implementation modes, those skilled in the art may clearly know that various implementation modes can be implemented by feat of software and necessary general hardware platform, or of course by means of hardware. Based on such an understanding, the foregoing technical solutions in essence or that part of contribution to the prior art may be embodied in the form of software products, which may be stored in computer-readable storage media, such as ROM/RAM, diskettes or optical disks and the like, including some instructions so that it is possible to execute embodiments or methods as recited in some parts of embodiments by a computer equipment (a personal computer, or a server, or network equipment, etc.).

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the spirit or scope of the technical solutions of the embodiments of the present disclosure.

What is claimed is:

1. A method for processing alarm information in a cloud computing, implemented by a server, comprising:
establishing a corresponding relation between services and physical resources of nodes at all levels, wherein the physical resources are relied on for executing the services; and
generating aggregated alarm information based on the corresponding relation between the services and the physical resources when a physical resource or a service gives alarms.

2. The method according to claim 1, wherein establishing a corresponding relation between services and physical resources of nodes at all levels comprises:
building a physical resource tree by classifying the physical resources according to a tree structure on a basis of a connecting relation, subordinating relation or coordinating relation of the physical resources; and
establishing a corresponding relation between the services and the physical resources of nodes at all levels, wherein the physical resources are relied on for executing the services.

3. The method according to claim 1, wherein generating aggregated alarm information based on the corresponding relation between the services and the physical resources comprises:
when physical resources of multiple congeneric slave nodes subordinate to physical resources of a master node are monitored to generate congeneric alarm information, aggregating the congeneric alarm information into fault information of the master node.

4. The method according to claim 1, wherein generating aggregated alarm information based on the corresponding relation between the services and the physical resources comprises:
when both the physical resources of nodes and the services corresponding to the physical resources of nodes are monitored to generate alarm information, aggregating alarm information generated by the physical resources of nodes and the services corresponding to them into one aggregated alarm information.

5. The method according to claim 1, wherein the physical resources comprise: host resources, disk resources and network resources; the host resources comprise a host and a switch; and the network resources comprise a network card.

6. An electronic device, comprising:
at least one processor; and
a memory communicably connected with the at least one processor for storing instructions executable by the at least one processor, wherein execution of the instructions by the at least one processor causes the at least one processor to:
establish a corresponding relation between services and physical resources of nodes at all levels, wherein the physical resources are relied on for executing the services; and
generate aggregated alarm information based on the corresponding relation between the services and the physical resources when a physical resource or a service gives alarms.

7. The electronic device according to claim 6, wherein establishing a corresponding relation between services and physical resources of nodes at all levels comprises:
building a physical resource tree by classifying the physical resources according to a tree structure on a basis of a connecting relation, subordinating relation or coordinating relation of the physical resources; and
establishing a corresponding relation between the services and the physical resources of nodes at all levels, wherein the physical resources are relied on for executing the services.

8. The electronic device according to claim 6, wherein generating aggregated alarm information based on the corresponding relation between the services and the physical resources comprises:
when physical resources of multiple congeneric slave nodes subordinate to physical resources of a master node are monitored to generate congeneric alarm information, aggregating the congeneric alarm information into fault information of the master node.

9. The electronic device according to claim 6, wherein generating aggregated alarm information based on the corresponding relation between the services and the physical resources comprises:
when both the physical resources of nodes and the services corresponding to the physical resources of nodes are monitored to generate alarm information, aggregating alarm information generated by the physical resources of nodes and the services corresponding to them into one aggregated alarm information.

10. The electronic device according to claim 6, wherein the physical resources comprise: host resources, disk resources and network resources; the host resources comprise a host and a switch;
and the network resources comprise a network card.

11. A non-transitory computer-readable storage medium storing executable instructions that, when executed by an electronic device with a touch-sensitive display, cause the electronic device to:
establish a corresponding relation between services and physical resources of nodes at all levels, wherein the physical resources are relied on for executing the services; and
generate aggregated alarm information based on the corresponding relation between the services and the physical resources when a physical resource or a service gives alarms.

12. The non-transitory computer-readable storage medium according to claim 11, wherein establishing a corresponding relation between services and physical resources of nodes at all levels comprises:
building a physical resource tree by classifying the physical resources according to a tree structure on a basis of a connecting relation, subordinating relation or coordinating relation of the physical resources; and
establishing a corresponding relation between the services and the physical resources of nodes at all levels, wherein the physical resources are relied on for executing the services.

13. The non-transitory computer-readable storage medium according to claim 11, wherein generating aggregated alarm information based on the corresponding relation between the services and the physical resources comprises:
when physical resources of multiple congeneric slave nodes subordinate to physical resources of a master node are monitored to generate congeneric alarm information, aggregating the congeneric alarm information into fault information of the master node.

14. The non-transitory computer-readable storage medium according to claim 11, wherein generating aggregated alarm information based on the corresponding relation between the services and the physical resources comprises:
when both the physical resources of nodes and the services corresponding to the physical resources of nodes are monitored to generate alarm information, aggregating alarm information generated by the physical resources of nodes and the services corresponding to them into one aggregated alarm information.

15. The non-transitory computer-readable storage medium according to claim 11, wherein the physical resources comprise: host resources, disk resources and network resources; the host resources comprise a host and a switch; and the network resources comprise a network card.
